(19) United States
(12) Patent Application Publication
(10) Pub. No.: US 2022/0290467 A1
(43) Pub. Date: Sep. 15, 2022

(54) METHOD OF OPERATING A VEHICLE LOCK

(71) Applicant: ABUS August Bremicker Soehne KG, Wetter-Volmarstein (DE)

(72) Inventors: Manuel BANSE, Herborn (DE); Stefan Heinemann, Wetter (DE)

(21) Appl. No.: 17/689,955

(22) Filed: Mar. 8, 2022

(30) Foreign Application Priority Data
Mar. 9, 2021 (DE) 10 2021 105 648.9

(51) Int. Cl. E05B 71/00; B62M 6/90

(52) U.S. Cl. CPC E05B 71/00; B62M 6/90

(57) ABSTRACT

Disclosed is a method of opening a vehicle lock having a locking mechanism, including the following steps: transferring a blocking element of a blocking device by means of an actuator from a blocking position into a release position, wherein the blocking element blocks the actuation of the locking mechanism in the blocking position and releases the actuation of the locking mechanism in the release position; manually actuating an actuation element arranged at the lock; and transferring the actuation element from a passive state to an active state, wherein a latch of the locking mechanism is transferred from a latched position into an unlatched position by transferring the actuation element from the passive state to the active state, wherein the latch prevents a removal of a counter-piece from the lock in the latched position and allows a removal of the counter-piece from the lock in the unlatched position.

The invention relates to a method of operating a vehicle lock comprising a locking mechanism.

Such vehicle locks, in particular for two-wheelers, bicycles, scooters or electric bicycles, are generally known and may, for example, comprise a battery compartment lock, a frame lock, a brake disk lock, a seat compartment lock, a lock for a transport box, i.e. a case lock, a hoop lock, a folding lock, or similar locks. Locks that may be electrically actuated and that, for example, enable a keyless unlocking are particularly convenient. If a powerful locking mechanism is to be used to ensure a high level of security against an unauthorized or unintentional opening of the lock, a strong and thus large, heavy, and expensive electrical actuator having a high energy requirement is required for the actuation of said locking mechanism.

It is an object of the invention to provide a method of operating a vehicle lock that ensures a convenient operation with a simultaneously increased security and increased economy.

The object is satisfied by a method having the features of claim 1, and in particular in that an opening of the lock comprises the following steps: transferring a blocking element of a blocking device by means of an actuator from a blocking position into a release position, wherein the blocking element blocks the actuation of the locking mechanism in the blocking position and releases the actuation of the locking mechanism in the release position; manually actuating an actuation element arranged at the lock; and transferring the actuation element from a passive state to an active state, wherein a latch of the locking mechanism is transferred from a latched position into an unlatched position by transferring the actuation element from the passive state to the active state, wherein the latch prevents a removal of a counter-piece from the lock in the latched position and allows a removal of the counter-piece from the lock in the unlatched position. After the completion of the actuation of the actuation element, said actuation element is transferred from the active state to the passive state and the latch is transferred from the unlatched position into the latched position, whereas the blocking element remains in the release position.

In accordance with the invention, a two-stage method is therefore provided for operating the lock, in which, on the one hand, the desired locked or unlocked state of the lock is established directly by means of the locking mechanism and, on the other hand, a blocking device controls the actuation of the locking mechanism. In a locked and blocked state of the lock, in which the locking mechanism is in the locked position and the blocking device is in the blocking position, an unintentional or unauthorized unlocking of the locking mechanism, for example by vibrations when traveling over uneven terrain or by a manipulation of the lock, is thus particularly effectively prevented.

It is understood that the lock that may be operated by the method in accordance with the invention has at least the following components: the locking mechanism comprising the latch and the actuation element, and the blocking device comprising the blocking element and the associated actuator.

The lock may, for example, be a battery compartment lock, a frame lock, a brake disk lock, a seat compartment lock, a lock for a transport box, i.e. a case lock, a hoop lock, a folding lock, or a similar lock, in particular of a motorcycle, a motor scooter, a scooter, a bicycle, in particular an electric bicycle.

The locking mechanism comprises a latch that may be latch-like or bolt-like or that may also be configured as a hoop, a catch, a ball, or a roller. In its latched position, the latch locks the lock, in particular in that the latch is in engagement with a counter-piece such that the counter-piece cannot be removed from the lock. For example, the counter-piece may have a cut-out into which the latch engages, or vice versa. The latch may alternatively or additionally engage behind a structure attached to the counter-piece, or vice versa. The counter-piece may be either a component of the lock itself, for example a closing hoop or a bolt, or also an object not belonging to the lock or a section thereof, such as an object to be secured in or by means of the lock, for example, a battery to be secured in the lock or a section thereof. To unlock the lock, the latch is moved into an unlatched position, in particular the latch and the counter-piece are therefore brought out of engagement. The transfer of the latch between the latched and unlatched position may comprise a rotational and/or a translational movement of the latch.

Depending on the design of the lock, the opening may comprise different steps. In a battery lock, the opening of the lock may comprise an unlocking of the battery lock and a removal of the battery. In the case of a frame lock, a case lock, or a brake disk lock, an unlocking and a release of a closing hoop or of another counter-piece from the locking mechanism may be provided.

The locking mechanism is actuated by a user by means of an actuation element. The actuation takes place manually and without the use of a key. Depending on the design of the lock, considerable forces are effective to hold the latch in the latched position, in particular such that a secure locking of the lock and consequently a securing of e.g. a closing hoop or a battery is ensured. A manual actuation of the actuation element allows the overcoming of these forces in order to move the latch into the unlatched position on the opening. A key or another operating means for the unlocking of the locking mechanism may hereby be omitted in a particularly convenient manner.

The actuation element may have a handle such as a turning handle, a slider, a push button, a lever, or a drawbar eye. The actuation may comprise a translational and/or rotational movement of the actuation element by a user, i.e. the actuation element may be rotated, displaced, pushed, pivoted, or pulled by a user depending on an embodiment.

Due to the actuation, the actuation element is transferred between a passive state and an active state. In this respect, the actuation element is coupled to the latch such that an adjustment of the latch into the unlatched position takes place due to the transfer of the actuation element from the passive state to the active state. The movement of the actuation element may be transmitted directly or by means of a transmission section to the locking mechanism, in particular to the latch. The transmission section may, for example, comprise a gear by which the movement of the actuation element may be converted into a movement of the latch with a deviating magnitude and/or a deviating direction. The coupling between the latch and the actuation element may be designed bidirectionally such that a movement of the latch from the latched position into the unlatched position causes a transfer of the actuation element from the passive state to the active state. Conversely, it is also possible that a movement of the latch from the latched position into the unlatched position does not change the state of the actuation element, for example, by a free lift function or freewheeling function provided at the actuation element or in the transmission section.

The blocking device comprises a blocking element and an actuator for adjusting the blocking element from the blocking position into the release position and vice versa. The actuator may be an electrical actuator such as an electromechanical actuator or an electromagnetic actuator. Since no large forces act on the blocking element itself, in particular since the blocking element does not take over a holding function in the lock, for example for a closing hoop or a battery, an electrical actuator of low power, and thus having a small weight, space requirements and cost, is typically sufficient for adjusting the blocking element.

The energy supply of the blocking device, in particular of the actuator, may take place by a battery attached to the lock or to the blocking device itself. Alternatively or additionally, the energy supply of the blocking device may take place by an energy source arranged outside the lock. For example, a central energy supply of the vehicle, such as a vehicle battery, may supply the blocking device with energy. In the case of a battery lock, this may, for example, be the battery to be secured in the battery lock.

The blocking element may be pin-like or bolt-like, but may also be spherical, cylindrical, or wedge-shaped. In its blocking position, the blocking element may be in engagement with the locking mechanism and/or with the actuation element such that an adjustment of the latch into the unlatched position and/or an actuation of the actuation element is blocked. The blocking element may in this respect be in engagement with the latch, a handle, and/or a transmission section. For example, in the blocking position, the blocking element may engage into a cut-out of the locking mechanism and or of the actuation element and may be released therefrom on its adjustment into the release position. The adjustment of the blocking element between the blocking position and the release position may comprise a translational and/or a rotational movement of the blocking element.

After the unblocking and unlocking of the lock, the blocking element may remain in its release position. The lock is hereby in a kind of standby state in which a repeat closing of the lock is possible without a user action for adjusting the blocking element into the release position being necessary beforehand. This is in particular advantageous when a counter-piece has been removed from the lock after the transfer of the latch from the latched position into the unlatched position. This or another counter-piece may then be reinserted into the lock and in particular into the locking mechanism without the blocking element previously having to be moved into the release position.

Advantageous embodiments of the invention may be seen from the dependent claims, from the description, and from the drawing.

In accordance with an embodiment, the transfer of the actuation element from the active state to the passive state and/or the transfer of the latch from the unlatched position into the latched position is automatically effected by a return element. Since the actuation element automatically returns to its passive state again, i.e. therefore so-to-say to its starting state, after the completion of an actuation by the user, a practical one-handed operation may be implemented. The return element may, for example, be charged or preloaded by transferring the actuation element to the active state and/or by transferring the latch into the unlatched position, i.e. the transfer to the active state or into the unlatched position takes place against a return force of the return element. The return element may, for example, be a return spring. The actuation element and the latch may be automatically transferred to the passive state or to the latched state by the same return element. This enables a saving of components and installation space in particular in the case of a bidirectional coupling of the latch and the actuation element. Alternatively, the latch and the actuation element may each be automatically transferred to the latched state or the passive state by their own return element.

In accordance with a further embodiment, the transfer of the blocking element from the blocking position into the release position takes place when the blocking device receives a release command that is transmitted to the blocking device by a control device arranged outside the lock. Such a release command may in particular be generated by a user input at the control device. The release command may be an electrical signal. The processing of control commands, such as a release command, in the blocking device may take place by a controlling device of the blocking device. In dependence on the received control command, the blocking device may activate and deactivate the actuator to adjust the blocking element between the blocking position and the release position. When the blocking device receives a release command transmitted by the control device, it may initiate an adjustment of the blocking element by the actuator without any further user action being necessary.

The control device may, for example, be a smartphone, a smartwatch, or another computer, in particular a portable computer. However, the control device may also be an onboard computer of the vehicle. A software application which has a graphical user interface and by means of which the user may control the lock may be present on the control device.

The release command may be transmitted in a wireless or wired manner, in particular also in an encrypted manner, from the control device to the blocking device. A connection between the control device and the blocking device may, for example, be established by means of wireless communication technologies for the close range (such as Bluetooth, WLAN, RFID) or cellular networks (such as WIFI, GSM, GPRS, 3G, 4G, 5G), or long-distance networks that are also called long-range networks. The lock and the control device may be configured such that the blocking device already receives a release command from the control device when the control device approaches the lock up to a previously defined distance or enters a reception range of the lock. The distance may be configurable by a user.

The control device may authenticate itself with respect to the blocking device. This may, for example, take place by exchanging electronic keys. The blocking device may be configured such that, on a successful authentication of a control device, it receives, processes, and/or executes control commands from this control device. Alternatively or additionally, it may be necessary that the user proves his authorization for generating a control command by inputting a secret code, in particular at the control device, or by a user authentication at the control device, for example, by means of biometric features or an authentication code. The control device may be configured to control a plurality of blocking devices, wherein in particular a one-time user authentication may be sufficient to enable the operation of one or more locks via the control device after a successful authentication of the user at the control device.

In accordance with an embodiment, the transfer of the blocking element from the blocking position into the release position is prevented during the travel of the vehicle. If the lock is, for example, a battery compartment lock, the interruption of the energy supply, on the one hand, and the loss of the battery during the journey due to an unintentional opening of the lock, on the other hand, may be prevented in this manner. Equally, an unwanted opening of the transport box during the travel may be prevented, for example, in the case of a case lock and the loss of the hoop and/or of the lock body may be prevented in the case of a hoop lock.

The movement state of the vehicle may be determined by means of a sensor. Alternatively or additionally, data on the movement state may be derived from the state of a drive motor of the vehicle and may in particular be provided by a control of the drive motor. The blocking device itself, and in particular a controlling device of the blocking device, may query and/or receive the sensor data on the movement state and may also in the case of a possibly present release command only activate the actuator to adjust the blocking element into the release position when the standstill of the vehicle is ensured.

In accordance with a further embodiment, a movement state of the vehicle is determined by means of a control device, in particular a control device arranged outside the lock such as an onboard computer or a smartphone. The control device may, for example, query movement data from corresponding sensors or from a drive motor of the vehicle. The control device may, for example, only transmit a release command when the standstill of the vehicle was previously determined.

If the lock is, for example, a frame lock or a brake disk lock, provision may also be made that the transfer of the blocking element from the release position into the blocking position is prevented during the travel of the vehicle.

In general, the transfer of the blocking element from the blocking position into the release position or vice versa may be prevented during the travel of the vehicle. This generally increases the safety for the user since the user is not distracted during the travel by an actuation of a lock and unforeseen and unintentional changes to the lock during the travel may moreover be avoided.

In accordance with an embodiment, a closing of the lock may comprise the following steps: inserting a counter-piece into the locking mechanism; transferring the latch into the latched position, wherein, in the latched position, the latch and the counter-piece are in engagement with one another such that a removal of the counter-piece from the locking mechanism is prevented; and transferring the blocking element from the release position into the blocking position.

The latch may be temporarily transferred into its unlatched position, in particular against the return force of a return element, during the insertion of the counter-piece. On the insertion into the lock, the counter-piece may in particular press onto the latch such that said latch is transferred into the unlatched position, in particular wherein the return element is preloaded or charged by the movement of the latch into the unlatched position. If the counter-piece is completely inserted into the lock, i.e. if the counter-piece is in the position in which it is secured in the latched position by the latch, the latch gains space to move and may be moved back into its latched position by the return element that is in particular preloaded. In this way, a latch function of the lock may be implemented by which the latch is automatically transferred into the latched position after the insertion of the counter-piece.

In addition, the actuation element may be temporarily transferred to its active state during the insertion of the counter-piece, in particular in the case of a bidirectional coupling between the latch and the actuation element.

In accordance with an embodiment, a position of the latch, of the actuation element, of the counter-piece, and/or of the blocking element is queried by means of a suitable sensor device prior to the transfer of the blocking element into the blocking position. The position information may be determined by one or more suitable sensors that query the position of one or more components of the lock and/or of an object to be secured, e.g. a bicycle battery. For example, stop sensors or switches that may be actuated by the counter-piece, the latch, and/or the actuation element may be provided that are actuated on the reaching of a specific position of the element associated with them.

The sensor information may be queried, received, and/or processed either directly by the controlling device of the blocking device or by a control device arranged outside the lock. The control device and the controlling device of the blocking device may be configured for a communication, in particular a wireless communication, in particular in two directions. For example, results of the sensor query or other information may be exchanged between the control device and the blocking device.

If, for example, the positions, determined by a sensor, of one or more of the components detected by sensors are not in an intended state or an intended position, the output of an error message or of a warning may be provided. For example, an error message may be output on a display by the control device, wherein the respective element may specifically be mentioned, or an acoustic alarm may be output by the control device. Alternatively or additionally, the blocking device itself may output a warning message, in particular a warning tone.

In accordance with an embodiment, the transfer of the blocking element into the blocking position only takes place when a predetermined time period has elapsed since the insertion of the counter-piece, the transfer of the latch into the latched position, and/or the transfer of the actuation element to the passive state. The transfer of the blocking element into the blocking position may take place automatically without an user action after the time period has elapsed. Sensors for a position determination may be combined with a time recording to query the elapsed time period, wherein the position and time information may be queried, received, and/or processed by the blocking device itself or by the control device. The time period may be selected as so large that the user has sufficient time to check the correct seat of the counter-piece after the insertion of the counter-piece. Furthermore, the time period may be selected as so small that the vehicle has not already started travel before the blocking element closes. For example, the time period may be in the range of a few seconds.

In accordance with a further embodiment, the transfer of the blocking element into the blocking position only takes place when an evaluation of the sensor query reveals that the counter-piece is inserted, the latch is in the latched position, and/or the actuation element is in the passive state. A jamming of the lock during the closing or damage to the mechanical components of the lock caused by collisions may be effectively prevented in this manner.

Alternatively or additionally, the transfer of the blocking element into the blocking position only takes place when the blocking device receives a blocking command that is transmitted to the blocking element by a control device arranged outside the lock. Such a blocking command may be generated by a user input at the control device. Alternatively, the control device may automatically perform the transmission of a blocking command, in particular based on results of the sensor queries described above and/or on elapsed time periods. If a blocking command is input by the user, the control device may delay the transmission of said blocking command to the blocking device until all the sensor queries confirm that the components detected by sensors are in the respective intended state or in the respective intended position and/or that all the predetermined time periods have elapsed.

In accordance with a further embodiment, the transfer of the blocking element into the blocking position only takes place when a contact to a voltage supply for the actuator of the blocking element is established by the inserted counter-piece. If the lock is a battery lock and the counter-piece is a battery, the battery may be provided as the energy supply of the actuator. Due to the insertion of the battery into the lock, an electrical contact between the battery and the actuator may be simultaneously established such that the actuation of the actuator is made possible. A frame lock, a brake disk lock, or a case lock may also, for example, use a battery of the vehicle as an energy supply for the blocking device. For example, due to the insertion of the counter-piece, a switch arranged in the lock may be actuated or an electrical contact that establishes the power supply of the actuator may be established by the counter-piece. The actuator may automatically adjust the blocking element into the blocking position as soon as it is supplied with energy. In accordance with this embodiment, an adjustment of the blocking element into the blocking position by the actuator may only take place when the counter-piece is present. It is thus ensured that the blocking element always remains in the release position when the counter-piece is absent such that the insertion of the counter-piece is conveniently possible without an additionally necessary adjustment of the blocking element into the release position.

The lock may be set into a blocked sleep state when it receives a sleep command from a control device arranged outside the lock, for example, when the control device is removed from the vehicle or when a predetermined time period has elapsed since the lock was closed. In the blocked sleep state, the blocking element may be in the blocking position, the actuation element may be in the passive state, and the latch may be in the latched state. Furthermore, it may be necessary for a counter-piece to be inserted into the locking mechanism to be able to set the lock into the blocked sleep state. In the blocked sleep state, the closed lock, i.e. the locked and blocked lock with the counter-piece inserted, has a high security against an unauthorized access, for example, when the vehicle is parked for a specific time.

The lock may also be set into an unblocked sleep state when it receives a sleep command from a control device arranged outside the lock, for example, when the control device is removed from the vehicle or when a predetermined time period has elapsed since a counter-piece was removed from the lock. In the unblocked sleep state, the blocking element is in the release position, the actuation element is in the passive state, and the latch is in the latched state. A counter-piece may not be inserted into the locking mechanism to be able to set the lock into the unblocked sleep state, i.e. in the unblocked sleep state, the lock is in the standby state.

In the blocked and/or in the unblocked sleep state, the control device may be decoupled from the lock or may generally be switched off and may thus not be connected to the lock. The setting into a sleep state may, for example, take place by removing an onboard computer from the vehicle. It may be necessary for the vehicle to be at a standstill to be able to set the lock into a sleep state.

In contrast to the sleep state, the lock may adopt a blocked travel state during the travel, i.e. during a movement of the vehicle, in which the blocking element may likewise be in the blocking position, the actuation element may be in the passive state, and the latch may be in the latched state. A prerequisite for this may be that the control device is connected to the lock and is active. Furthermore, the presence of a counter-piece in the lock may be required to establish the blocked travel state. In the absence of a counter-piece, an unblocked travel state may be defined with the blocking element in the release position, with the actuation element in the passive state, and with the latch in the latched state.

The invention will be explained only by way of example in the following with reference to possible embodiments and to the drawing. There are shown:

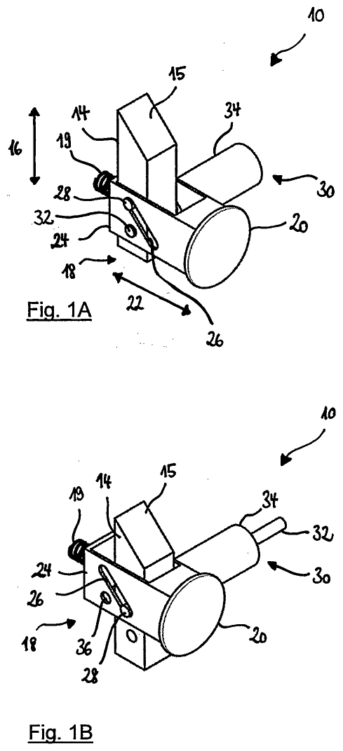

FIG. 1A an exemplary lock having a locking mechanism and a blocking device in a locked and blocked state;

FIG. 1B the lock of FIG. 1A in an unlocked and unblocked state;

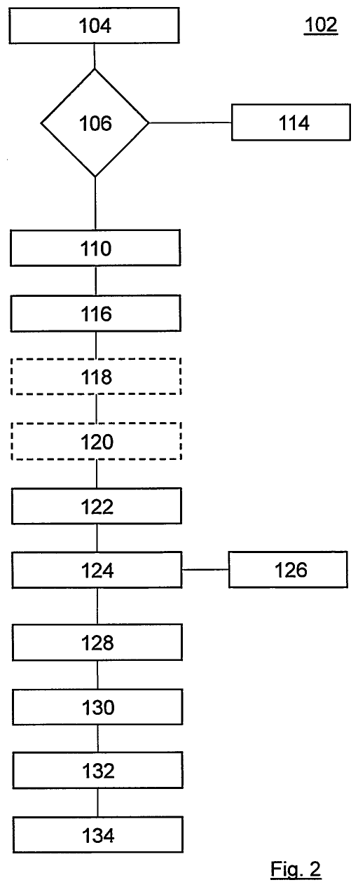

FIG. 2 a flowchart relating to the opening of the lock of FIG. 1;

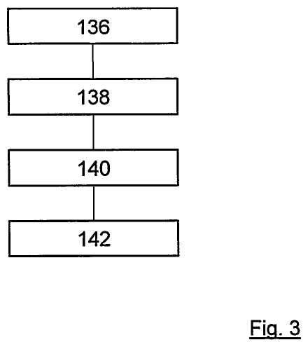

FIG. 3 a flowchart relating to the removal of an energy store from the lock of FIG. 1;

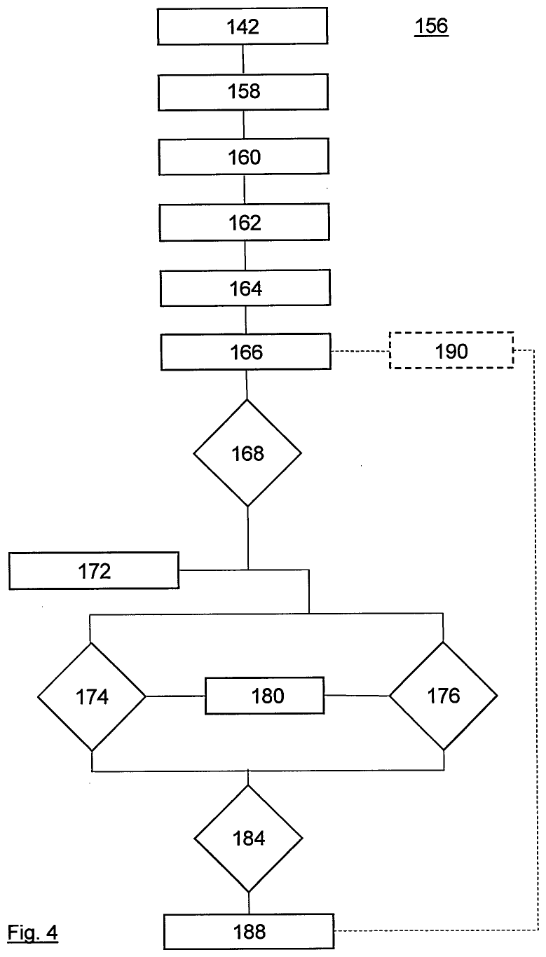

FIG. 4 a flowchart relating to the closing of the lock of FIG. 1; and

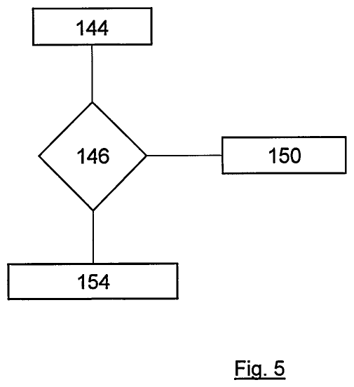

FIG. 5 a flowchart relating to the setting of the lock of FIG. 1 into a sleep state.

FIGS. 1A and 1B show purely by way of example a lock 10 of a vehicle that may be operated in accordance with the invention. In FIG. 1A, the lock 10 is shown in a locked and blocked state and, in FIG. 1B, the lock 10 is shown in an unlocked and unblocked state.

The lock 10 comprises a locking mechanism having a latch 14 that is movable between a latched position (FIG. 1A) and an unlatched position (FIG. 1B). In this respect, a translational movement of the latch 14 along the direction of the arrow 16 is provided. In the latched position, the latch is in engagement with a counter-piece, not shown, that is held in a latching manner in the lock 10 by the latch 14. The counter-piece may be part of the lock 10, for example a closing hoop or a bolt of the lock 10, or may be arranged at an object external to the lock, for example, at a battery of the vehicle.

An actuation of the latch 14 takes place by means of an actuation element 18 comprising a push button 20. In its passive state, the actuation element 18 is in the latched position of the latch in accordance with FIG. 1A, i.e. the push button 20 is not pressed in. On an actuation, i.e. on a pressing in of the push button 20, the actuation element 18 is transferred along the direction of the arrow 22 into its active position. This is a translational actuation movement. The push button 20 is connected to a transmission section 24. A slot guide 26, in which pins 28 formed at the latch 14 are guided, is arranged in the transmission section 24. The translational actuation movement of the push button 20 (arrow 22) is transmitted to the latch 14 and is converted (arrow 16) into a translational movement of the latch 14 directed perpendicular to said translational actuation movement by the slot guide 26 and the pins 28.

The actuation element 18 cooperates with a spring 19 such that a transfer of the actuation element 18 to its active state takes place against the return force of the spring 19, whereby the spring 19 is preloaded. If the push button 20 of the actuation element 18 is released in its active state, it is automatically returned to its passive state by the return force of the spring 19. Since the latch 14 and the push button 20 are bidirectionally coupled to one another by the slot guide 26 and the pins 28, the latch 14 is entrained and transferred into its latched position on a transfer of the actuation element 18 to the passive state.

The lock 10 further has a blocking device 30 comprising a pin-like blocking element 32 and an electric motor actuator 34. By means of the actuator 34, the blocking element 32 may be adjusted along its longitudinal axis between a blocking position (FIG. 1A) and a release position (FIG. 1B) in which the blocking element 32 is received in the actuator. In the blocking position, the blocking element 32 projects from the actuator 34 at the side of the latch 14 and is in engagement with the latch 14, which is in the latched position, and a cut-out 36 of the transmission section 24. Thus, both an actuation of the push button 20 and a movement of the latch 14 are blocked by the blocking element 32 that is in the blocking position.

The blocking device 30 furthermore comprises a controlling device, not shown, that is configured to control the actuator 34 and thus to control the adjustment of the blocking element 32 between the blocking position and the release position. The blocking device 30 is configured for a wireless reception of control commands, in particular release and blocking commands. The blocking device 30 receives these control commands from a control device arranged outside the lock 10, for example, from its onboard computer of the vehicle (not shown).

The lock 10 in accordance with FIGS. 1A, 1B may, for example, be a frame lock, a case lock, a brake disk lock, or a seat compartment lock. In addition, the lock 10 may serve to secure an energy store, e.g. a battery, i.e. a battery lock.

In the following, an actuation sequence will be explained by way of example for a battery lock for securing an energy store in a battery compartment of an electric bicycle. FIG. 2 shows a flowchart of the processes that play a role in the opening 102 of the battery lock. The starting point is a battery lock with the energy store inserted, with the locking mechanism in the locked position, and with the blocking element 32 in the blocking position (cf. FIG. 1A). In the latched position, the latch 14 engages into a cut-out of the energy store and thus secures it in the battery compartment. For a control of the battery lock by a user, an onboard computer arranged outside the battery lock at the electric bicycle is provided with a software application and a touch-sensitive screen in the present embodiment example. A smartphone may generally also serve as the control device.

If the user intends to remove the energy store from the battery compartment, the user inputs a command for removing the energy store at the control device (step 104). During the travel of the vehicle, an adjustment of the blocking element 32 of the battery lock 10 into the release position is to be prevented under all circumstances—on the one hand, in order not to interrupt the energy supply of, for example, a drive motor of the vehicle, and, on the other hand, in order to avoid a vibration during the travel from unintentionally causing a movement of the latch 14 into the unlatched position, whereby a loss of the energy store would be imminent. In a query step, the control device therefore first determines the movement state of the electric bicycle (step 106).

The movement state may, for example, be determined from a speed of rotation of a drive motor of the electric bicycle and/or by querying a sensor provided for this purpose. Alternatively, a determination of the movement state may be provided based on GPS data. If the query step 106 reveals that the electric bicycle is stationary, the control device transmits a release command to the blocking device 30 (step 110). Otherwise, if the query step 106 reveals that the electric bicycle is in motion, the control device does not transmit a release command to the blocking device 30, but informs the user by means of an error message on the screen of the onboard computer that an opening of the battery lock 10 is not possible (step 114).

The blocking device 30, in particular a controlling device of the blocking device 30, receives the release command transmitted by the control device (step 116). Provision may be made that an authentication process takes place (step 118) in which the control device authenticates itself at the controlling device of the blocking device before the latter processes the release command. Alternatively or additionally, provision may be made that the release command transmitted by the control device is decrypted by the controlling device (step 120).

In step 122, in response to the release command, the controlling device activates the actuator 34 of the blocking device 30, which moves the blocking element 32 into its release position (step 124), while the actuation element 18 and the latch 14 remain for the time being in their passive state or their latched state. Provision may be made that a status message is output (step 126) on the display of the onboard computer and informs the user that the blocking element 32 has been adjusted into the release position and that an unlocking of the locking mechanism is possible.

The user then presses the push button 20 (step 128) and thus transfers the actuation element 18 from its passive state to its active state (step 130), whereby the latch 14 is moved from the latched position into the unlatched position (step 132). The latch 14 is in this respect moved out of the cut-out of the energy store and no longer secures said energy store in the battery compartment. The user may then remove the energy store from the battery compartment (step 134).

As shown in FIG. 3, the user releases the push button 20 again (step 136) after the user has removed the energy store from the battery compartment. The push button 20 is transferred to its passive state (step 138) by the spring 19 shown in FIGS. 1A, 1B. At the same time, the latch 14 is entrained into its latched position by the slot guide 26 (step 140). The blocking element 32, in contrast, remains in its release position in the absence of the energy store, i.e. in the absence of the counter-piece. The battery lock is so-to-say in a standby state 142 in which the insertion of the energy store is possible at any time.

In FIG. 4, it is schematically shown which processes play a role in the closing 156 of the lock, i.e. when the user, for example after a charging process, reinserts the energy store into the battery compartment to secure it therein. The starting point is that the battery lock is in the standby state 142, i.e. the blocking element 32 is in its release position, the actuation element 18 is in its passive state, and the locking mechanism is in its locked position.

The user first inserts the energy store, i.e. the counter-piece, into the locking mechanism (step 158). During the insertion, the energy store comes into contact with the latch 14, in particular with a chamfered end face 15 of the latch 14, whereby said latch 14 is successively pressed into its unlatched position by the insertion movement of the energy store (step 160). At the same time, the actuation element 18 is entrained via the pins 28 and the slot guide 26 and is transferred from the passive state to the active state (step 162). In addition, the spring 19 is preloaded.

When the energy store approaches its fully inserted position, the latch 14 may engage into a cut-out of the energy store provided for this purpose and is thus no longer forced into the unlatched position by the energy store. As soon as this force is omitted, the actuation element 18 is transferred to its passive state by the preloaded spring 19 (step 164) and the latch 14 is in this respect entrained into its latched position (step 166). In the latched position, the latch 14 is now in engagement with the energy store such that it may no longer be removed from the battery compartment.

To block the locking mechanism in the locked position now reached, an adjustment of the blocking element 32 into its blocking position is to take place. First, to avoid malfunctions of the lock, a determination is made whether all the requirements for the adjustment of the blocking element 32 into the blocking position are met, namely whether the energy store is fully inserted into the battery compartment, whether the latch is in the latched position, and whether the actuation element is in the passive state. For this purpose, the battery lock has a sensor device for detecting the position of the counter-piece, i.e. of the energy store, of the latch 14, and/or of the actuation element 18. The sensor device may have one or more sensors, for example, stop sensors or switches.

In the embodiment example shown, provision is made that the determination of the position of the counter-piece, i.e. of the energy store, is detected without an additional sensor. Rather, the position of the energy store is to be detected by querying the existence of an electrical contact between the energy store and the blocking device (step 168). A successful establishing of the electrical contact in this case serves as a confirmation that the energy store has been fully inserted into the battery lock.

The insertion of the energy store into the battery lock may take place with the onboard computer deactivated and generally without the battery lock being connected to an energy supply. Provision may therefore be made that the successful establishing of the electrical contact activates the onboard computer of the vehicle (step 172) or that a connection, in particular a wireless connection, is established between the blocking device 30 of the battery lock and the onboard computer.

If the insertion of the energy store into the battery lock is confirmed, the position of the latch 14 is detected in a query step 174 and the position of the actuation element 18 is detected in a further query step 176. This may in each case take place by stop sensors or switches that may, for example, be actuated by the latch 14 and the actuation element 18 in the latched position and in the active state. If the query steps 174, 176 reveal that the latch 14 and/or the actuation element 18 is/are not in the intended position, a corresponding error message may be output (step 180), for example, on the screen of the onboard computer.

If it is confirmed by the sensor query that the latch 14 is in the latched position and the actuation element 18 is in the passive state, the time duration is recorded in a step 184 that has elapsed since the transfer of the counter-piece into its intended position, the transfer of the latch 14 into the latched state, and/or the transfer of the actuation element 18 to its passive state.

Only when a predetermined time period has elapsed in each case will a closing of the blocking element 32 be initiated in step 188. In this respect, provision may be made that each of the described sensor queries is performed and evaluated by the controlling device of the blocking device. If the sensor query reveals a deviation from the expected result, the controlling device may forward this via a wireless connection to the control device that then indicates a corresponding error message.

Alternatively, the sensor queries may be performed and evaluated by the control device. In this case, the control device only forwards a blocking command for adjusting the blocking element 32 into the blocking position to the blocking device 30 when all the sensor queries provide the expected result. Alternatively, the control device outputs an error message.

Provision may also be made that the user actively triggers the closing of the blocking element 32 after the insertion of the energy store by an input at the onboard computer (step 190). In this case, provision may additionally be made that the positions of one or more components of the battery lock and/or of the energy store are queried as described above to prevent malfunctions of and damage to the lock.

If the user moves away from the vehicle, provision may thus be made that the user removes the onboard computer from the electric bicycle (step 144) to deactivate the electric bicycle and to protect it against an unauthorized access (see FIG. 5). Alternatively, a switching off of the onboard computer or a disconnection of a wireless connection between the onboard computer and the battery lock may also be provided.

In this case, the battery lock is set into a sleep state. In a step 146, a determination is for this purpose first made whether a counter-piece, i.e. the energy store in the case of the battery lock, is in engagement with the locking mechanism, for example, via stop sensors or position sensors, via a query of an electrical contact that may be established by the counter-piece, or via a position of a switch that may be actuated by the counter-piece.

If the absence of a counter-piece of the battery lock is determined, the blocking element 32 thus remains in its release position or, if said blocking element 32 is not in the release position, it is adjusted into the release position (step 150). Thus, in the sleep state, the battery lock is also in a standby state in which the insertion of the energy store is directly possible, in particular without a prior user action or provision of a power supply for actuating the actuator 34 of the blocking device.

If a counter-piece is detected in the battery lock, the blocking element remains in its blocking position or, if said blocking element is not already in the blocking position, it is adjusted into the blocking position (step 154). The energy store inserted into the battery compartment is thus also securely protected against an unauthorized removal or a loss in the sleep state. In the sleep state, irrespective of the position of the blocking element 32, the push button is in its passive state and the locking mechanism is accordingly in its locked position.

### REFERENCE NUMERAL LIST

10 lock
14 latch
15 chamfered end face of the latch 14
16 direction of movement of the latch 14
18 actuation element
19 spring
20 push button
22 direction of movement of the actuation element 18
24 transmission section
26 slot guide
28 pin
30 blocking device
32 blocking element
34 actuator
36 cut-out
102 opening the battery lock
104 inputting a removal command
106 determining the movement state of the vehicle
110 transmitting a release command to the blocking device 30
114 error message “Opening of the lock not possible”
116 receiving a release command by means of the blocking device 30
118 authentication process
120 decrypting
122 activating the actuator 34
124 adjusting the blocking element 32 into the release position
126 status message “Unlocking possible”
128 user actuates the push button 20
130 transferring the actuation element 18 to the active state
132 entraining the latch into the unlatched position
134 removing the energy store by means of the user
136 releasing the push button 20
138 transferring the actuation element 18 to its passive state
140 entraining the latch into the latched position
142 standby state of the lock
144 removing the onboard computer from the vehicle
146 determining a counter-piece in the locking mechanism
150 blocking element 32 remains in the release position or is adjusted into it
154 blocking element 32 remains in the blocking position or is adjusted into it
156 closing the battery lock
158 inserting the energy store by means of the user
160 pressing the latch into the unlatched position
162 transferring the actuation element 18 to the active state
164 transferring the actuation element 18 to the passive state
166 entraining the latch 14 into its latched position
168 querying an electrical contact
172 activating the onboard computer
174 querying the position of the latch 14
176 querying the position of the actuation element 18
180 outputting an error message
184 querying the time duration since the position has been adopted by the counter-piece, the latch 14, and/or the actuation element 18
188 transferring the blocking element 32 into the blocking position
190 requesting the closing of the blocking element 32 by the user

1.-14. (canceled)

15. A method of operating a vehicle lock comprising a locking mechanism, wherein an opening of the lock comprises the following steps:
transferring a blocking element of a blocking device by means of an actuator from a blocking position into a release position, wherein the blocking element blocks the actuation of the locking mechanism in the blocking position and releases the actuation of the locking mechanism in the release position;
manually actuating an actuation element arranged at the lock; and transferring the actuation element from a passive state to an active state,
wherein a latch of the locking mechanism is transferred from a latched position into an unlatched position by transferring the actuation element from the passive state to the active state, wherein the latch prevents a removal of a counter-piece from the lock in the latched position and allows the removal of the counter-piece from the lock in the unlatched position,
wherein, after the completion of the actuation of the actuation element, said actuation element is transferred from the active state to the passive state and the latch is transferred from the unlatched position into the latched position, whereas the blocking element remains in the release position.

16. The method in accordance with claim 15,
wherein the transfer of the actuation element from the active state to the passive state is automatically effected by a return element.

17. The method in accordance with claim 15,
wherein the transfer of the latch from the unlatched position into the latched position is automatically effected by a return element.

18. The method in accordance with claim 15,
wherein the transfer of the blocking element from the blocking position into the release position takes place when the blocking device receives a release command that is transmitted to the blocking device by a control device arranged outside the lock.

19. The method in accordance with claim 18,
wherein the release command is generated by a user input at the control device.

20. The method in accordance with claim 15,
wherein the transfer of the blocking element from the blocking position into the release position is prevented during the travel of the vehicle.

21. The method in accordance with claim 15,
wherein a movement state of the vehicle is determined by means of a control device.

22. The method in accordance with claim 15,
wherein a closing of the lock comprises the following steps:
inserting a counter-piece into the locking mechanism;
transferring the latch into the latched position, wherein, in the latched position, the latch and the counter-piece are in engagement with one another such that a removal of the counter-piece from the locking mechanism is prevented; and
transferring the blocking element from the release position into the blocking position.

23. The method in accordance with claim 22,
wherein the latch is temporarily transferred into its unlatched position during the insertion of the counter-piece.

24. The method in accordance with claim 23,
wherein the latch is temporarily transferred into its unlatched position against the return force of a return element.

25. The method in accordance with claim 22,
wherein the actuation element is temporarily transferred to its active state during the insertion of the counter-piece.

26. The method in accordance with claim 22,
wherein a position of the latch, of the actuation element, of the counter-piece, and/or of the blocking element is queried by means of a suitable sensor device prior to the transfer of the blocking element into the blocking position.

27. The method in accordance with claim 22,
wherein the transfer of the blocking element into the blocking position only takes place when a predetermined time period has elapsed since the insertion of the counter-piece, the transfer of the latch into the latched position, and/or the transfer of the actuation element to the passive state.

28. The method in accordance with claim 26,
wherein the transfer of the blocking element into the blocking position only takes place when an evaluation of the sensor query reveals that the counter-piece is inserted, the latch is in the latched position, and/or the actuation element is in the passive state.

29. The method in accordance with claim 22,
wherein the transfer of the blocking element into the blocking position only takes place when the blocking device receives a blocking command that is transmitted to the blocking device by a control device arranged outside the lock.

30. The method in accordance with claim 22,
wherein the transfer of the blocking element into the blocking position only takes place when a contact to a voltage supply for the actuator of the blocking element is established by the inserted counter-piece.

31. The method in accordance with claim 22,
wherein the lock is set into a sleep state,
when it receives a sleep command from a control device arranged outside the lock,
when the control device is removed from the vehicle, or
when a predetermined time period has elapsed since the lock was closed,
wherein, in the sleep state, the blocking element is in the blocking position, the actuation element is in the passive state, and the latch is in the latched state.
